(19) United States
(12) Patent Application Publication
(10) Pub. No.: US 2005/0172464 A1
(43) Pub. Date: Aug. 11, 2005

(54) Monolithic sealed urn

(76) Inventor: Michael Henry Horton, Livonia, MI (US)

Correspondence Address: Philip Horton, 2119 Grenadier, Troy, MI, 48098, US

(21) Appl. No.: 10/774,793

(22) Filed: Feb. 9, 2004

(51) Int. Cl. A61G 17/00

(52) U.S. Cl. 27/1

(57) ABSTRACT

A single-layer monolithic sealed cremation urn constructed of either acrylic with mineral fillers or an acrylic/polyester blend. The urn is comprised of six pieces, including the top, bottom and four sides. These pieces are assembled with two-part epoxy or other adhesive to achieve an inseparable mechanical and chemical bond. The final piece is bonded in position after the cremation remains have been placed inside the urn. The completed assembly is a fully sealed urn having a solid-surface exterior. A notable feature is that the remains enclosed by the urn are inaccessible except by destroying the urn. Indicia (such as the name and life span of the deceased human or animal) may be etched in relief into the top or side surface(s) to become an integral part of the urn.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

1. Field of Invention

This invention relates to cremation urns used in the funeral and death care industry for the storage of human or animal remains.

2. Background of the Invention

Cremation urns are used extensively for encasing the ash remains of humans and animals. The use of urns continues to grow due both to an increasing quantity of dying persons and animals, and also to the increasing percentage of deceased humans and animals that are cremated.

Many patents have been issued for cremation urns, dating at least back to 1874 with U.S. Pat. No. 7,599 issued to H. E. Wesche. Numerous patents since have been for specific ornamental designs. In addition, utility patents have been issued that involve unique attributes of materials, construction, and functionality with respect to cremation urns and related paraphernalia. The various cremation urns in the prior art each have advantages and disadvantages with respect to other designs.

Desirable attributes for cremation urns are that they provide a secure and durable housing for ash remains; that they be resistant to breakage, degradation or other damage in the environments and circumstances they are likely to encounter; that they provide a dignified and aesthetically pleasing appearance suitable for religious and burial customs; that they be suitable for the intended disposition of the ash remains (i.e., display, interment, burial at sea, columbarium or mausoleum storage); that they be capable of displaying indicia in a lasting and pleasing manner; that they be lightweight and inexpensive; and fundamentally that they imbue peace of mind to those living who love the deceased human or animal.

The present invention fulfills these individual and collective attributes to a greater extent than cremation urns described in the prior art. Of particular significance is the entirely monolithic and sealed aspect of the present invention. It is unknown in the prior art for a single-layer urn to be such that the ash remains are inaccessible without physically destroying the urn. This aspect of the present invention provides the essentially important peace of mind that the ash remains are safe and secure, and that there is no risk or opportunity for the remains to become exposed.

Beyond aspects that are generally common to cremation urns, a limited number of prior patents have specific aspects similar to the present invention. Representative examples are identified and contrasted to the present invention as follows:

U.S. Pat. No. 2,562,726 suggests a hardenable plastic composition, and also a monolithic design. This plastic composition is different from the metal, porcelain, wood, and glass materials most frequently used for making urns. The plastic composition is not the same, however, as the acrylic or acrylic/polyester blend of the present invention. With respect to monolithic design, U.S. Pat. No. 2,562,726 is a dual-layer construction involving mechanical assembly hardware, unlike the single-layer and hardware-free aspects of the present invention.

U.S. Pat. No. 5,230,127 suggests indicia that are an integral part of the urn wall. That invention notes sand blasting of decorative stone for indicia in relief and casting of bronze for raised indicia. In contrast, the present invention posits a laser etching method for creating indicia in relief, and also is specific to an urn made with acrylic or acrylic/polyester blend, materials ideally suited to this method.

U.S. Pat. No. 5,732,452 suggests a decorative outer casing made from acrylic. That patent describes a complex dual-layer urn utilizing mechanical assembly hardware. The present invention is a single-layer and hardware-free urn construction.

U.S. Patent Application 20030208889 suggests an urn that is resistant to degradation in a variety of environments, including outdoor, semi-outdoor, water, or marine environments. That patent achieves this functionality by using titanium, whereas the present invention achieves this functionality by using much less expensive acrylic or acrylic/polyester materials.

### BRIEF SUMMARY OF THE INVENTION

The present invention provides a unique and improved urn for the reception of human or animal remains as compared to the prior art by virtue of its design, materials, and manufacturing processes.

A key aspect of the invention is that the urn is monolithic and entirely sealed upon completion of the assembly process, as explained further in the detailed description. Accordingly, the completed urn provides the functionality and external appearance of a single, contiguous enclosure. The completed urn has inconspicuous and inseparable seams at the mating surfaces of the individual pieces comprising the urn. This construction provides a secure and inaccessible receptacle for the ashes. A key object of this fully sealed design is to provide emotional peace of mind from knowing that the remains are safe and secure, that there is no risk of inadvertent spillage of the enclosed remains, and by mitigating any morbid temptation to expose the human or animal remains.

Another aspect of this invention is that the primary material used to construct the urn is either a homogeneous blend of acrylics with mineral filler, or an acrylic/polyester blend.

Another object of the present invention is to provide an urn wherein the assembly seams are effectively imperceptible to the naked eye, thereby providing the monolithic appearance of a single, contiguous, enclosure.

Another object of the present invention is to provide an urn that is highly resistant to degradation from environmental exposure, thereby making the urn suitable for indoor, semi-outdoor, outdoor, underground, fresh water, or seawater environments. Minor discoloration that might occur after prolonged environmental exposure is easily removed by buffing the outer surface of the acrylic urn.

Another object of the present invention is to enable the size, shape, and color of the urn to be easily tailored to accommodate the applicable volume of remains, optimally fulfill the intended use of the urn (display, interment, burial at sea, columbarium or mausoleum storage), and satisfy desired aesthetics.

Another object of the present invention is to provide a burial urn that can accommodate indicia etched into the acrylic surface so as to become an integral part of the urn, or indicia on a separate plaque or plate that may be affixed to the urn.

Another object of the present invention is to provide a burial urn that is lightweight and inexpensive.

### BRIEF DESCRIPTION OF THE SEVERAL VIEWS OF THE DRAWING

FIG. 1 is a top view of the top surface of the completed urn.

FIG. 2 is a three-quarter view of the completed urn.

FIG. 3 illustrates the six pieces used to construct the urn, as well as a typical location for the two-part epoxy, cement, silicone, or other adhesive used to assemble the urn.

FIGS. 4, 5 and 6 illustrate example profiles along the top perimeter of the urn.

FIGS. 7 and 8 illustrate two alternatives for indicia. FIG. 7 depicts an urn that has been etched so that the indicia are an integral part of the urn. FIG. 8 illustrates a lower-cost alternative of mounting a plaque to the surface of the urn.

### DETAILED DESCRIPTION OF THE INVENTION

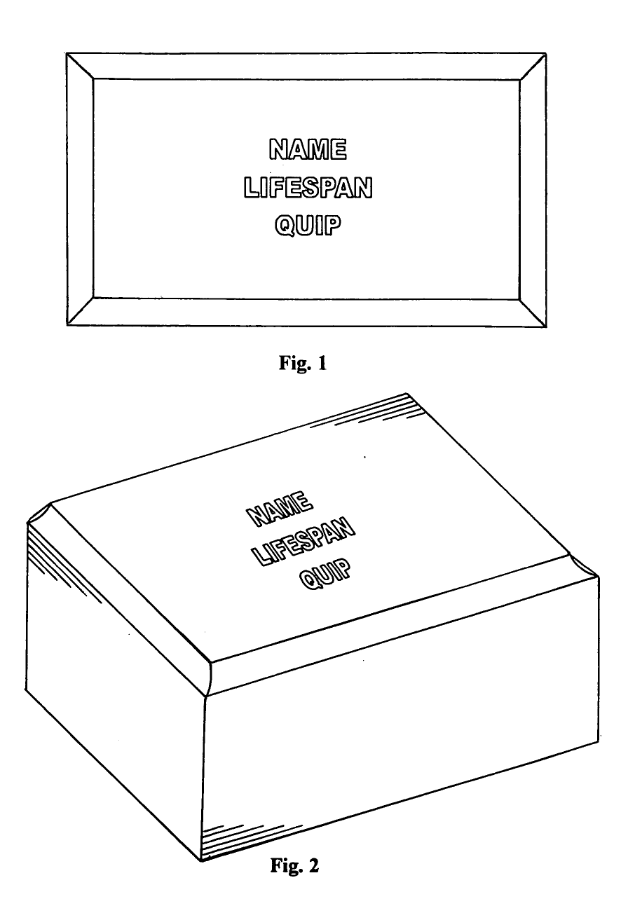

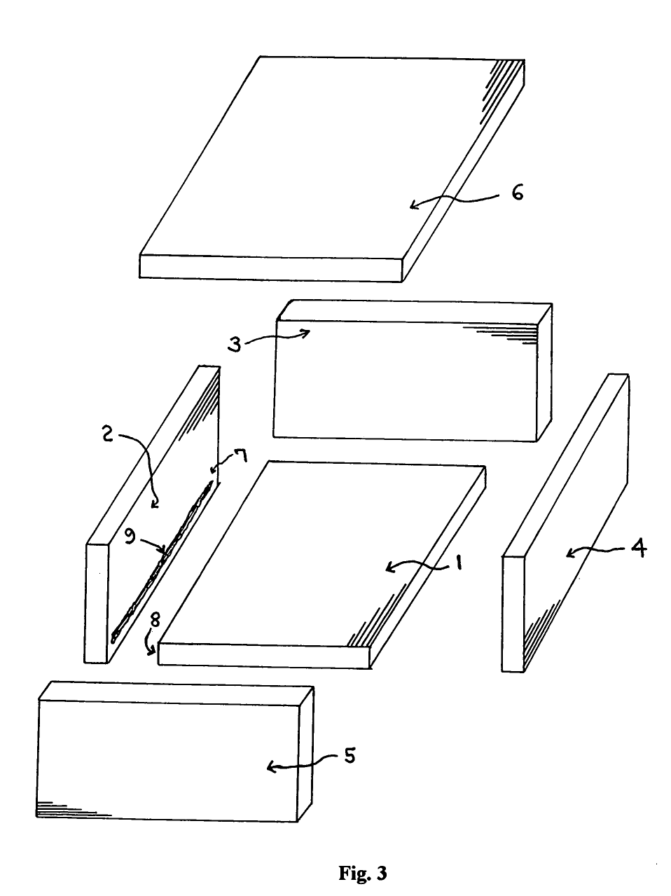

FIGS. 1 and 2 depict a top and three-quarter view of the monolithic sealed urn. A preferred embodiment of the present invention is best described with reference to FIG. 3.

A preferred embodiment begins with a homogeneous mixture of acrylic resins and mineral fillers. An alternative material having similar properties and suitable for the present invention is an acrylic/polyester blend. Common dimensions for sheets of this acrylic material are ½-inch thickness×36-inch width×72-inch length, although the sheets are readily available in other sizes. Acrylic sheets are available in a multitude of colors, including uniform colors and various patterns. A preferred embodiment of the present invention would utilize a fine-patterned design to most effectively conceal the seams of the finished urn.

Acrylic sheet is readily cut into smaller pieces using a standard table or miter saw with carbide blade. FIG. 3 shows six pieces of acrylic that have been cut from sheet. These include the bottom piece 1, side pieces 2 through 5, and top piece 6. These six pieces are used to construct a single urn. The dimensions of these individual pieces are easily tailored so that the completed urn will be of a size and shape appropriate for the applicable volume of remains, to fulfill the intended use of the urn (display, interment, burial at sea, columbarium or mausoleum storage), and to satisfy desired aesthetics.

The six pieces of acrylic are bonded together to produce the urn. A typical bonding location is the lower surface 7 of side piece 2 that mates with side edge 8 of bottom piece 1. The mating surfaces are first scuffed by sanding or other means in order to maximize the effectiveness of the adhesive. A preferred embodiment would utilize two-part epoxy as the adhesive, depicted by bead 9 along lower edge 7. Two-part epoxy provides a mechanical and chemical bond that is effectively inseparable and stronger than the acrylic material itself. It is also desirable to utilize an adhesive that is color-keyed to the acrylic to most effectively conceal the external seams of the completed urn. Alternatives to two-part epoxy include cement or silicone.

A representative assembly sequence would be to apply the two-part epoxy to the lower surface of side pieces 2 and 4, and then mate these surfaces to their respective edges of bottom piece 1. These pieces are then clamped together for the time required for the adhesive to react and set. In similar fashion, side pieces 3 and 5 are bonded to their respective edges of bottom piece 1. Note that side pieces 2 and 4 have the same length as bottom piece 1, whereas side pieces 3 and 5 are of sufficient width to overlap the width of bottom piece 1 as well as to the edge thicknesses of side pieces 2 and 4. This scheme is utilized throughout so that the external surfaces of the completed urn will be flush and square along each (height, width, and length) perimeter.

Once five pieces of the urn have been bonded together (the subassembly of pieces 1 through 5 in the current description), the next required step before the final piece can be bonded in position is for the cremation remains to be placed into the subassembly. This is necessary since there will be no opportunity to add or remove remains from the fully assembled urn without destroying the urn. After the remains are placed into the five-piece subassembly, the final top piece 6 is bonded in position by the same method described above.

In addition to the representative assembly sequence described above, the preferred embodiment of the present invention would include several finishing operations, as follows:

The seams created at the interfaces of the six acrylic pieces are worked after assembly in order to provide a smooth surface whereby the external seams are effectively imperceptible to the naked eye. This provides the monolithic appearance of the urn that is a key aspect of the present invention. From coarse to fine, these operations could entail cutting, filing, sanding, and/or buffing along all seams.

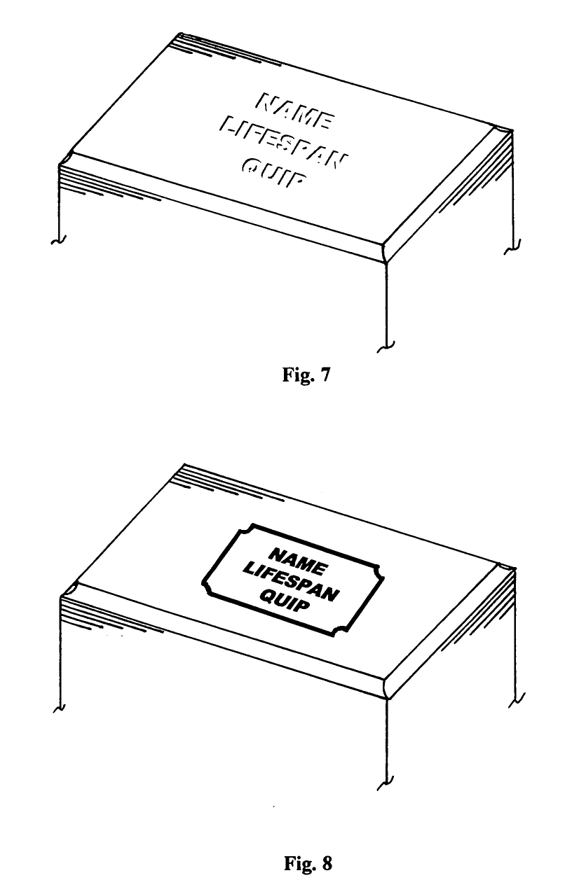

Indicia are added to the top and/or side surface(s) of the urn. A most preferred embodiment would be to etch the indicia in relief, such that the indicia would become an integral part of the monolithic urn. The acrylic material of the present invention is ideally suited to etching. A lower-cost embodiment would be to affix a plaque or plate with the desired indicia to the external surface of the urn. An expedient way to accomplish this would be double-sided adhesive tape between the surface of the urn and the underside of the plaque. FIG. 7 depicts indicia etched in relief, while FIG. 8 shows the embodiment of a separate plaque affixed to the urn.

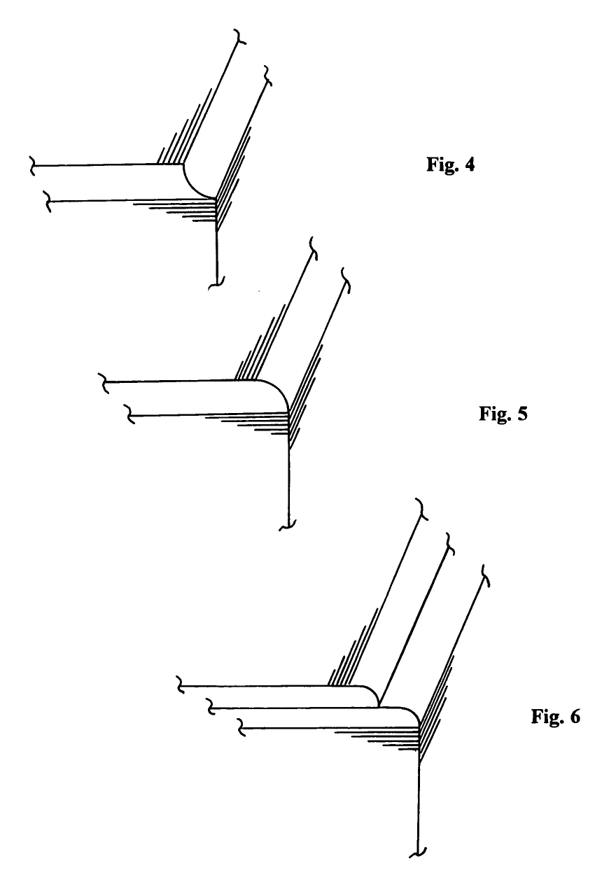

The most preferred embodiment includes a profile along the top perimeter of the urn. Such profile is readily created using a router. FIGS. 4, 5, and 6 depict three example profiles, although the present invention is not limited to these, as anyone skilled in the art could readily devise alternative profiles.

While the above description conveys a detailed description of what is intended for the present invention, those skilled in the art will recognize that various modifications to the same can be accomplished without departing from the spirit of the present invention. Such modifications are contemplated herein.

1. A monolithic single-layer cremation urn capable of holding the remains of a deceased human or animal wherein the urn is made of either acrylic with mineral filler or an acrylic/polyester blend.

2. The urn of claim 1, wherein the individual acrylic or acrylic/polyester pieces comprising the urn are bonded together using either two-part epoxy, cement, or silicone.

3. The urn of claim 1 constructed in such a manner that prevents access to the remains held within the urn unless the urn is destroyed.

4. The urn of claim 1 constructed such that the external mating seams of the individual pieces comprising the urn are effectively imperceptible to the naked eye.

5. The urn of claim 1 that may be constructed to varying sizes, shapes, colors, and patterns to fulfill specific needs as to the volume of remains to be held, the intended disposition of the urn (display, interment, burial at sea, columbarium or mausoleum storage), and desired aesthetics.

6. The urn of claim 1, wherein indicia may be either etched in relief to become an integral part of the urn or affixed by means of a separate plaque or plate. Indicia are most appropriately added to the top and/or side surface(s) of the urn.

7. The urn of claim 1, wherein various profiles may be added along the top or other edges of the assembly using a router or other tool.

8. The urn of claim 1, which due to its material composition and construction resists degradation, breakage or other damage after prolonged exposure to indoor, semi-outdoor, outdoor, underground, fresh water, or seawater environmental conditions.
